(19) United States
(12) Patent Application Publication
(10) Pub. No.: US 2010/0314440 A1
(43) Pub. Date: Dec. 16, 2010

(54) System and Method of Information Management in a Healthcare Setting

(76) Inventor: Christopher D. Maloney, Lake Forest, IL (US)

Correspondence Address: LOEB & LOEB, LLP, 321 NORTH CLARK, SUITE 2300, CHICAGO, IL, 60654-4746, US

(21) Appl. No.: 12/141,030

(22) Filed: Jun. 17, 2008

(51) Int. Cl. G06Q 50/00; G06K 7/14; G06K 19/06

(52) U.S. Cl. 235/375

(57) ABSTRACT

An information system for use, at least, in the healthcare field which includes an electronically accessible data record and a hand-held stationary device which reads an invisible printed code on a substrate, is uploaded with subject-specific information, and can further upload subject-specific information into the data record. The hand-held device at least includes an optical reader capable of reading the selected printed code; a non-volatile memory; a controller; and an audio speaker. Also disclosed is a method of maintaining real-time information regarding a patient in a healthcare: facility using a patient identification bracelet with a device having an optical reader capable of reading a selected one of the one or more printed codes on the patient identification bracelet and capable of providing humanly perceptible feedback.

### BACKGROUND OF THE INVENTION

1. Field of the Invention

This invention relates in general to information management and in particular to a system for integrating physical articles with recorded information.

2. Description of the Related Art

Related systems are known in the prior art, especially in the area of children books and educational books. Specifically other systems have disclosed encoding techniques and similar techniques wherein there is invisible code embedded under visible indicia. For example, U.S. Pat. No. 7,350,718 discloses a document, with indexes and associated document reader. The document is constructed by printing plural pixels and divided into plural areas. Each of the areas has plural indexes respectively consisting of a group of indexing dots to represent an area code corresponding to the area. The document is read according to the different optical reflection features of the pixels which are filter, recognized by a pattern sensor and decoded. U.S. Pat. No. 5,329,108 discloses a map with indexes and an associated document reader. The indexes are composed of a group of dots placed on the map in the vicinity of the associated elementary area. The dots form a specific code for the area and are readable by an optical reader.

Although, there are known systems which use invisible embedded invisible code, there has been no development of technology in fields outside the foregoing fields where similar technology would prove to be beneficial.

### SUMMARY OF THE INVENTION

By the present invention, the use of encoding techniques wherein there is invisible code embedded under visible indicia is expanded to applications in the healthcare field.

An object of the invention is to provide an information system comprising an electronically-accessible data record, including a patient data record; a substrate having thereon one or more printed codes practically imperceptible to a human being; and a device having an optical reader capable of reading a selected one of the one or more printed codes on the substrate, non-volatile memory and a controller, the device further having means for providing humanly perceptible feedback, and the non-volatile memory storing the patient data record.

Another object of the invention is to provide one or more printed codes on the substrate, wherein there can be a pre-printed material visible to the naked eye which is in substantial registration with at least one or more of the printed codes.

Another object of the invention is to provide printed codes on an intermediate substrate, which has at least one of an adhesive layer and a protective layer, neither which is made of a material that obscures the ability of the optical reader to read the printed code.

Another object of the invention is to provide the intermediate substrate on a sheet with one or more immediate substrates, wherein the individual intermediate substrates can be of different shapes.

Another object of the invention is to provide the device with circuitry for updating the non-volatile memory.

Another object of the invention is to provide the device with a means for recording dates into a device.

Another object of the invention is to provide varying forms of substrates for various uses in the healthcare field.

Another object of this invention is to provide a patient identification bracelet as a substrate, wherein the bracelet is associated with a patient in a healthcare facility.

Another object of the invention is to provide a system wherein a radio transceiver sends the recorded data via the first and second radio transceivers to the data record creation, storage and update subsystem along with a device identification code and data sufficient to determine a patient identification code, the device identification code being stored in the non-volatile memory of the device and the data sufficient to determine the patient identification code being read from the printed codes on the patient identification bracelet.

Another object of the invention is to provide a second substrate wherein the second substrate is a prescription label, the second substrate having thereon one or more printed codes practically imperceptible to a human being, the optical reader capable of reading a selected one of the one or more printed codes on the second substrate, the non-volatile: memory having code stored therein to operate the controller to provide humanly perceptible feedback indicative of the desirability of providing the prescription medication to the patient.

Another object of the invention is to provide a method of maintaining real-time information regarding a patient in a healthcare facility comprising printing a patient identification bracelet associated with the patient; associating one or more codes printed on the patient identification bracelet such that they are practically imperceptible to a human being with personal data regarding the patient; placing the patient identification bracelet physically on the patient; touching the patient identification bracelet with a device having an optical reader capable of reading a selected one of the one or more printed codes on the patient identification bracelet, non-volatile memory and a controller, the device further having means for providing humanly perceptible feedback; and providing humanly perceptible feedback related to the touched one or more printed codes on the patient identification bracelet.

These and other objects and advantages of the present disclosure will be apparent to those of ordinary skill in the art having the present drawings, specifications, and claims before them. It is intended that all such additional systems, methods, features, and, advantages be included, within this description, be within the scope of the disclosure, and be protected by the accompanying claims.

### BRIEF DESCRIPTION OF THE DRAWINGS

FIG. 1 of the drawings is an exploded view of the printed code 50 associated with various substrates 155 and a representative view of the hand-held device 300.

FIG. 2 of the drawings is an illustration of the use of stickers to carry the printed code 50 for association with the substrate, which is subsequently covered by a practically transparent substrate.

FIG. 3 of the drawings is a representation of the components comprising the hand-held device 300.

FIG. 4 of the drawings is a block diagram of the optical reader 310 shown in FIG. 3.

FIG. 5 of the drawings is an alternative embodiment of the hand-held device 300.

FIG. 6 of the drawings is an illustration of the entry of initial patient data into a patient records database 395 associated with the system.

FIG. 7 of the drawings is an illustration of printing a sheet of various sized labels and a patient identification bracelet associated with new patient admittance.

FIG. 8 of the drawings is an illustration of the patient identification bracelet 4000 that is generated for the patient upon admittance.

FIG. 9 of the drawings is an exploded view of the information portion of the patient identification bracelet 4000.

FIG. 10 of the drawings is an illustration of one manner of connecting the hand-held device to the remainder of the system such that patient data may be saved in substantially real-time if the radio frequency link is active.

FIG. 11 of the drawings is an illustration of one manner of connecting the hand-held device to the remainder of the system showing collection of patient data through microphone 345 and organization of same in the patient records database 395.

FIG. 12 of the drawings is an illustration of a prescription drug verification function of the system.

FIG. 13 of the drawings is an illustration of the prescription bottle substrate 155.

### DETAILED DESCRIPTION OF THE DISCLOSURE

While the present disclosure may be embodied in many different forms, the drawings and discussion are presented with the understanding that the present disclosure is an exemplification of the principles of one or more inventions and is not intended to limit any one of the inventions to the embodiments illustrated.

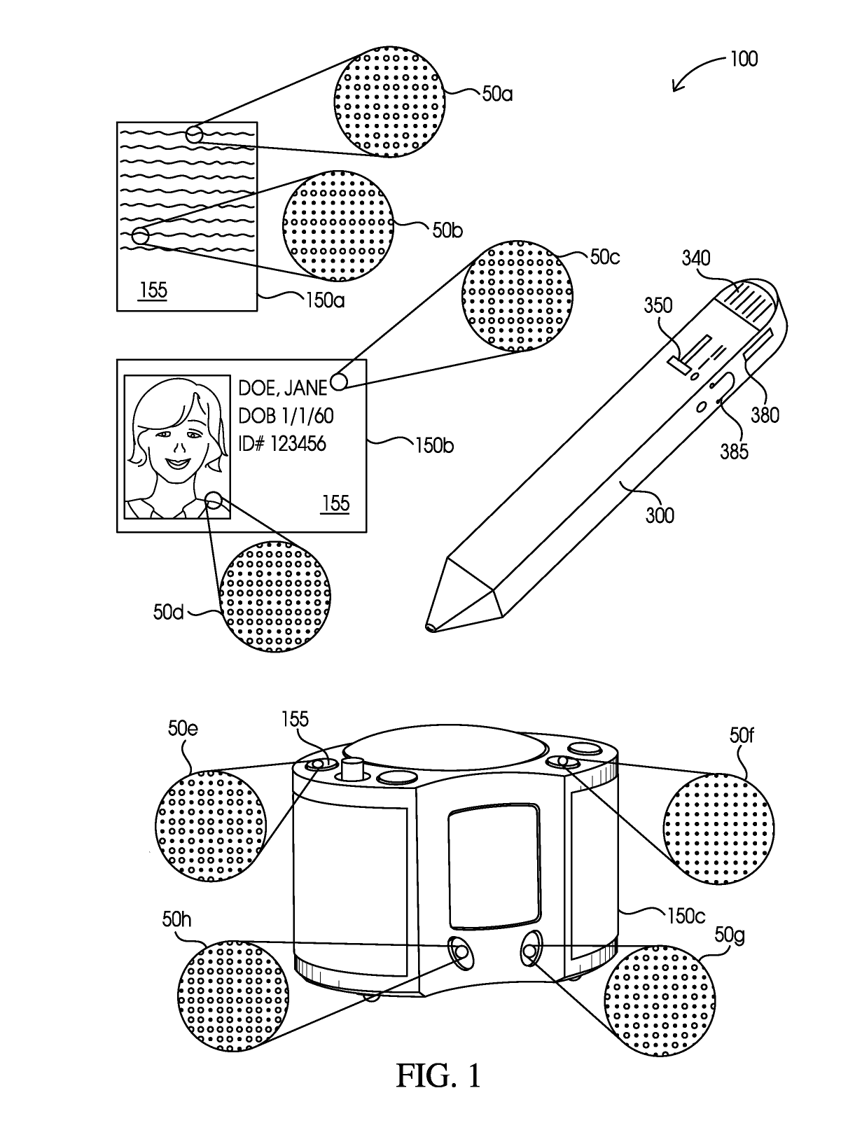

As shown in FIG. 1, a system 100 including a printed code 50 printed on a substrate 155 and a hand-held device 300 is disclosed. While the specification will primarily speak in terms of hand-held device 300, it is contemplated that the hand-held device 300 could be replaced in some system 100 by a non-portable, stationary device.

Various types of printed codes may be used in the system 100, including those types of encoding techniques taught by U.S. Pat. Nos. 3,786,237; 4,604,065; 4,627,819; 4,990,093; 5,329,108; 5,416,312; and 7,350,718. Other types of printed codes are also contemplated as being within the scope of the present disclosure. The printed codes may be printed in association with the process of mass printing visible indicia on one or more printed pages, such as is disclosed in U.S. Pat. Nos. 3,786,237; 4,604,065; 4,627,819; 4,990,093; 5,329,108; 5,416,312; and 7,350,718. The printed codes may be printed before or after the visible indicia as part of the same printing process.

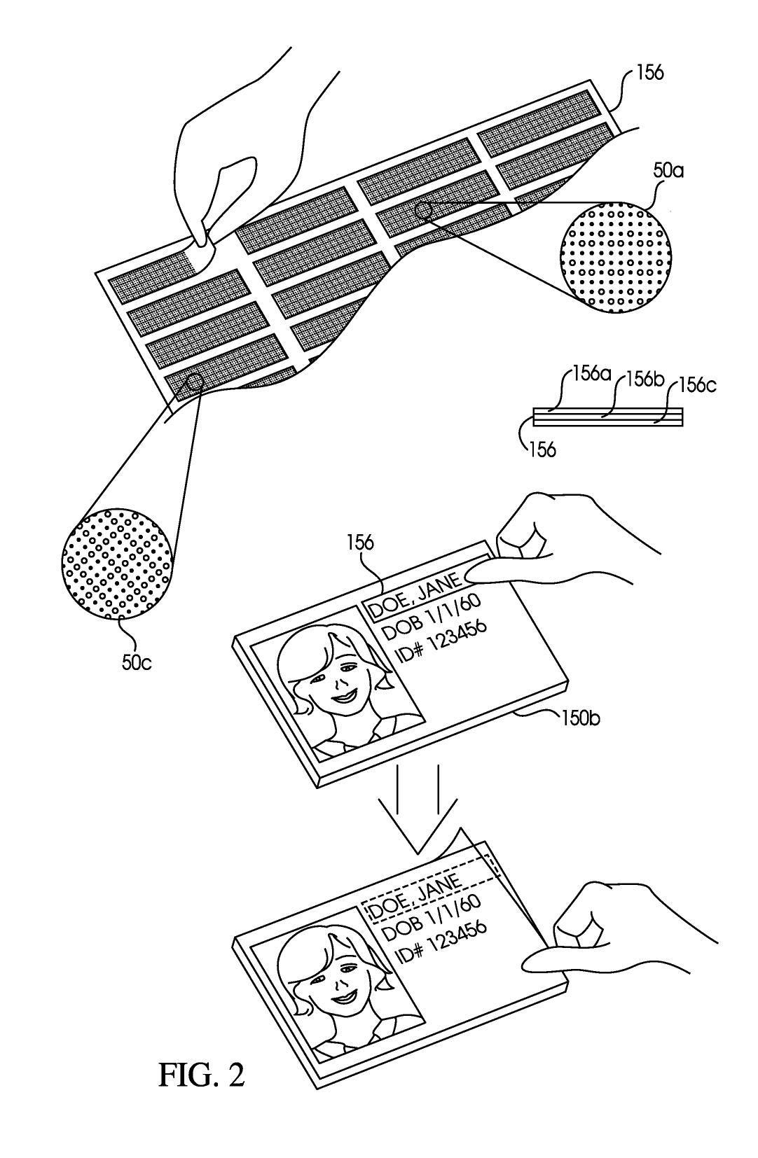

As depicted in FIG. 2, it is contemplated that the printed code 50 may be humanly perceptible before it has been physically associated with substrate 155. However, the printed code 50 is practically imperceptible to a human being once it has been associated with a substrate 155, such as printed matter 150a or even a surface of an article 150c (sec FIG. 1 or FIG. 2).

The term “article” for purposes of the present disclosure is intended to exclude mass printed matter, such as books, instruction booklets, magazines, newspapers, stock prospectuses, training guides, and user manuals. While “article” would certainly include three-dimensional objects, it is not intended that the meaning of “article” be so limited. So, for instance, electronic equipment (such as a DVD player), identification cards or passports, electronics (such as an alarm clock 150c, toaster, or microwave oven), medical devices, identification, cards 150b, medical identification bracelets, prescription medicine containers, and vehicles are all examples of “articles” that may be associated with this system. Articles and mass printed material may be collectively referred to as having substrates 155 upon which the printed codes 50 are placed.

Association of the printed code with substrate 155 may be achieved by directly printing on the substrate 155. The association of the printed code 50 with a previously created substrate 155 may be achieved by printing the codes directly on the previously created substrate 155 or via an intermediate substrate 156, which is then physically associated with the substrate 155. As shown in FIG. 2, the intermediate substrate 156 may be an adhesive sticker having one or more layers of adhesive 156c and a printable layer 156b. In some embodiments, the adhesive sticker may further include a protective layer 156a on top of the printable layer, where the protective layer is made CH 6 such that it does not significantly obscure the ability of the hand-held device to read the printed code on the adhesive sticker. The adhesive sticker may be made of layers that, at most, do not significantly obscure the substrate 155 below. However, for some articles, the adhesive sticker may obscure what lies underneath. Adhesive stickers may be produced in pre-printed sheets or rolls for mass application during mass production of substrates.

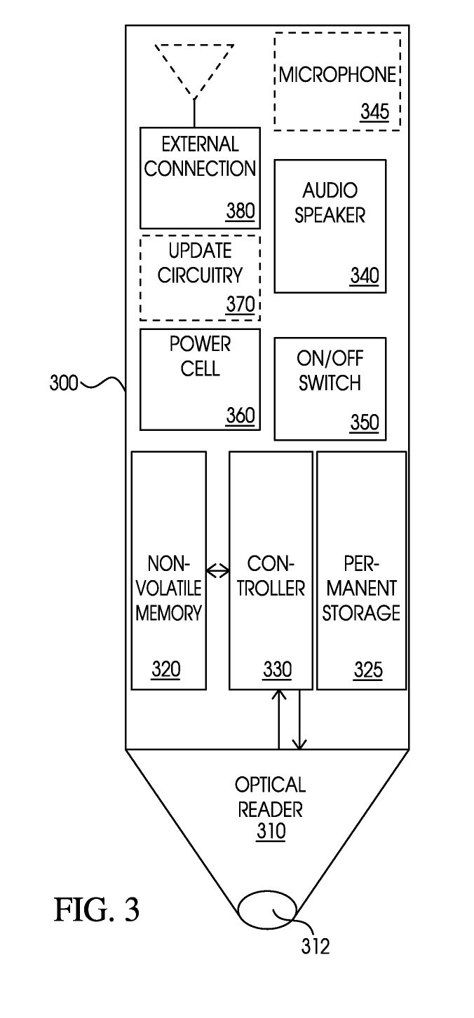

As shown in FIG. 3, the hand-held device 300 of the system 100 comprises an optical reader 310 capable of reading the selected printed code; non-volatile memory 320; a controller 330; an audio speaker 340; an on/off switch 350; and a power cell 360 (such as a battery). The interconnections between the elements are not shown because such connections are well understood and to avoid obscuring the invention. The hand-held device housing would most preferably be shaped like a pen, however, other housing shapes and sizes may also be used. It is contemplated that the system may be incorporated into any stationary or hand-held device so long as that device has the appropriate optical reader capabilities. So; for instance, it is contemplated that a mobile telephone having a CMOS camera could be used as the hand-held device 300 in the present system. While the present disclosure may speak in terms of “touching” the hand-held device or pen to the substrate, this term should be understood for purposes of the present disclosure to encompass, not only physically touching the hand-held device's sensor window 312 to the substrate 155, but also bringing the sensor window 312 in sufficiently close proximity to the substrate 155 for the optical reader 310 to read the selected printed code 50.

The non-volatile memory 320 of the hand-held device is preferably rewriteable and may be removable from the housing of the hand-held device. The non-volatile memory 320 may also be physically fixed within the hand-held device 300. The non-volatile memory 320 may be proprietary or may be selected from commonly available forms of non-volatile memory, such as EEPROM, EPROM, Flash Memory, SDRAM, SRAM, and memory cards, including, but not limited to, CompactFlash (CF), JEIDA, Memory Stick (MS/MS-PRO), miCard, Microdrive (MD), MultiMediaCard (MMC), Secure Digital (SD), microSD, SmartMedia (SM), and xD-Picture. The non-volatile memory 320 is used, among other things, to store the printed codes, audio, and programming used by the controller 330 to operate the desired functions of the hand-held device 300, as will be discussed more fully below. The audio may be encoded or raw and may comprise music, sound effects, and/or even speech synthesis data.

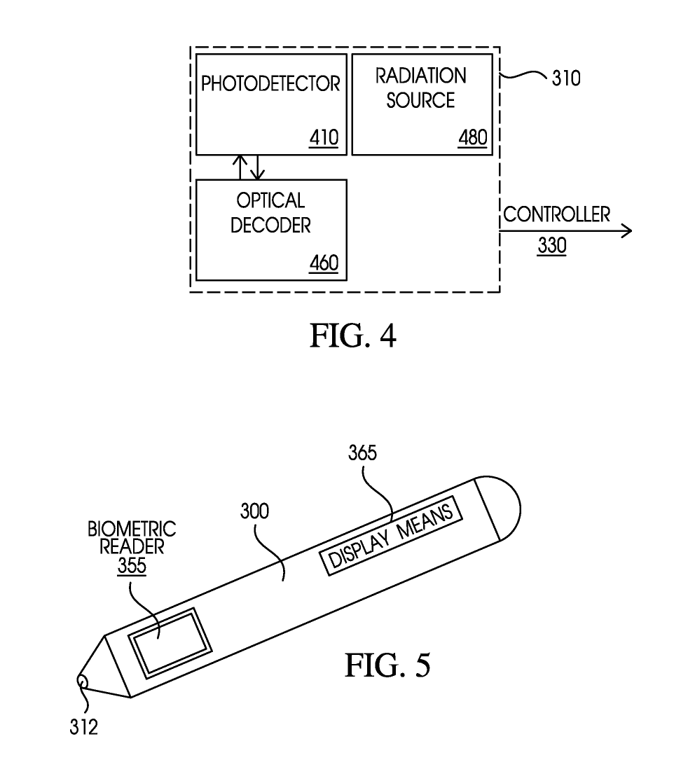

Preferably, the non-volatile memory 320 of the hand-held device is rewriteable, although it is possible that a portion of the non-volatile memory 320 will be write once storage (WORM) or even read only memory (ROM) which shall be referred to as permanent storage 325 (FIG. 3). It is contemplated that the hand-held device 300 may be assigned a unique identification number, which would be stored in either WORM or ROM either at the factory or by a company deploying the hand-held devices. Where the hand-held device 300 includes rewriteable memory, the device may further include circuitry capable of rewriting, the rewriteable, non-volatile memory 320. The update circuitry 370, as shown in FIG. 4, may interface with external devices, such as a specialized computer, a general-purpose computer, or a remote server, via a wired or a wireless connection.

Where the external connection 380 is wireless, the hand-held device 300 would further include a radio transceiver. The wireless connection could be 2G, 3G, Bluetooth, CDMA, DECT, TDMA, UMTS-TDD, WiBro, WiFi, or WiMAX to name a few. Wired, connections may be proprietary or constructed in accordance with a. standard such as USB or FireWire (IEEE-1394).

The controller 330 of the hand-held device 300 may be comprised of any group of electrical components, firmware and software sufficient to operate the functions of the hand-held device 300. Among the potential groups of electrical components for implementing the controller 330 are general-purpose microprocessors, special purpose microprocessors, and ASICs. The controller 330 will have likely have volatile memory elements (e.g. registers) and access to the non-volatile memory 320. In some instances, the controller 330, itself, will preferably have separate non-volatile memory 320, which comprises a part of the overall non-volatile memory 320 of the hand-held device 300. The controller 330 provides a means for controlling the functions of the hand-held device 300 and coordinating those functions to produce the functionality disclosed herein. The controller 330 may also keep real time or at least system time.

The audio speaker 340 of the hand-held device 300 is primarily used to provide audible instructions, information and other feedback to the user of the hand-held device 300. The controller 330 is operably connected to the audio speaker 340, such that pre-recorded audio, synthesized audio, or text-to-speech output may be audibly played through the audio speaker 340. It is contemplated that the hand-held device 300 could also include an audio jack such that an external headphone or independently-amplified external speaker could be used instead of or in addition to the audio speaker 340 in the hand-held device 300.

The on/off switch 350 of the hand-held device 300 is preferably a slider switch, but could be a momentary contact switch or any other type of electro-mechanical switch. In a preferred embodiment, the on/off switch 350 may be a three position slider switch. Those three positions are preferably: off, on at a low volume, and on at a higher volume. It would be understood by those skilled in the art having the present disclosure before them that the on/off switch 350 could be a two-position switch with preset volume or volume selectivity could be provided by a potentiometer with an adjustment wheel or knob accessible on the face of the housing.

The power cell 360 of the hand-held device 300 is preferably a battery. The battery may be a disposable or a rechargeable battery. In the case of a rechargeable battery, the hand-held device 300 would include charging circuitry and would preferably include software to optimize the recharging of the battery. As is known, where the hand-held device 300 includes a USB port (see 380, FIG. 1), external power may be provided to the device via the USB port to recharge the battery. In an embodiment with no physical ports, inductive charging may be used as is well known in the art. The hand-held device 300 would also preferably include a low-battery warning mechanism.

The hand-held device 300 may also optionally include a microphone 345. In such an embodiment, the controller 330 would also have the ability to record the audio input via the microphone 345. This recorded audio may be saved in its analog form or may preferably be digitized. In some embodiments, the controller 330 may include a speech-recognition engine that translates the audio into text. The audio or digital representation thereof (either pure digital or text-translation) may be stored by the controller 330 in the hand-held device 300 or that audio may be transmitted either wirelessly or by wire to or from a computer or remote server.

FIG. 4 shows the optical reader 310 includes a photodetector 410 and an optical decoder 460. The photodetector may comprise a single row, but preferably includes a two-dimensional array of semiconductor devices (such as a charge-coupled device (CCD) or CMOS optical sensors), each associated with an amplifier and an optical filter. The optical filter, generally allows a band centered wavelength of light to pass. The center of the band of frequency or frequencies selected depends upon the printed code system chosen. The size of the semiconductor row or array may also, be adjusted depending upon the printed code system selected. For instance, in an embodiment deployed with a mobile telephone CMOS camera at least three wavelengths will be filtered and, hence, sensed (blue, green, and red), so the printed code system may be selected to take advantage of the ability of an array to sense one, two or all three wavelength bands of light. In an embodiment where the printed code system relies on infrared wavelengths, the optical reader 310 may also include a source of infrared radiation 480, such as a LED and the filter pass-band would be selected accordingly. The image sensed by the photodetector 410 is read out into the optical decoder 460, which may be part of the controller 330 or a discrete set of circuitry. The optical decoder 460 gathers the sensed optical signals and translates those signals into images that are matched against the known aspects of the selected printed code. Once the optical signal is decoded, the information is passed out of the optical reader 310 to the controller 330.

As shown in FIG. 5, the hand-held device 300 may also optionally include a visual display means 365 on the housing. The visual display means 365 may be as simple as a single, colored light emitting diode or it may be as complex as a liquid crystal display (LCD) or LED display, such as those found in hand-held calculators. The controller 330 would drive the visual display means 365 as is known by those in the art.

As also shown in. FIG. 5, the hand-held device 300 may optionally include one or more biometric sensors 355, such as a fingerprint reader, or biometric analysis such as a voice-analyzer or handwriting analyzer. One or more of these biometric sensors 355 may be used alone or in combination with each other and/or a password to provide some level of security for the system. The controller 330 would support the biometric sensing capabilities using peripherals. For instance, where voice, analysis is used the microphone 345 would be used in combination with the controller 330 and memory to judge whether the user is matched with hand-held device 300. In another example where handwriting analysis is used, the hand-held device 300 would further include an ink cartridge and could further include an accelerometer and/or a pressure sensor to judge the speed, angle and pressure of the user's writing style. The hand-held device 300 may also have the ability to perform optical character recognition.

In an embodiment including biometric or other security, once the user identity is sufficiently confirmed, the hand-held device 300 may communicate with the outside world using unique identification number assigned to that the hand-held device 300. In secure transaction environments, the communications will be encrypted and otherwise secured by the controller 330. That communication may be further secured after the first communication hop taken by communication outside of the hand-held device 300, e.g. the personal computer to which the hand-device is operably coupled.

In an embodiment of the hand-held device 300 having the audio speaker 340, the multi-lingual and visually-impaired communications may impact each and every application. It should be relatively straightforward—based on the foregoing disclosure—to begin to understand how this system can help visually-impaired individuals by reading out loud printed matter from encoded substrates. The multi-lingual aspect requires some additional discussion. The substrate 155 may be printed in a manner that is appropriate for the majority of readers in a particular environment (e.g. English language in 12 pt font), yet the hand-held device 300 may be programmed to selectively read the substrate 155 in English or a different language, such as Chinese, French, Japanese, Polish, Russian, or Spanish, to name only a few potential languages. To facilitate the language change an icon printed on the substrate 155 to be read or on a separate command substrate 155 would visually convey to the user that touching the hand-held to the icon would change the language spoken by the hand-held device 300. The hand-held device 300 preferably responds by audibly indicating the language mode the device is in (e.g. “Españolé” for Spanish).

The hand-held device 300 may be used in a variety of applications, including in the healthcare field, including, but not limited to, patient identification bracelets, patient charts, and prescription labels.

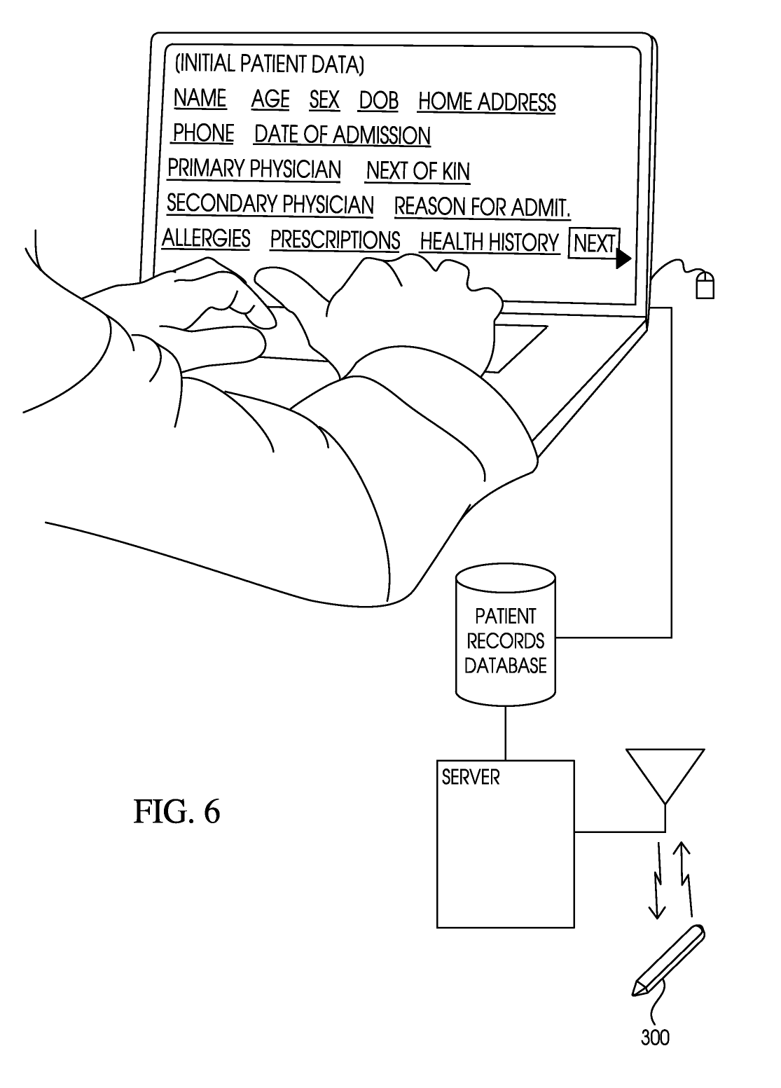

As shown in FIG. 6, as part of the admissions process for the patient, a data record would be created by entering information into a hospital admissions database 395 including, for example, the patient's name (e.g. Smith, John M) and the other information that is commonly visibly depicted on a patient identification bracelet. As shown in FIG. 6, this data record may include additional information beyond that printed on a typical patient id bracelet as well as additional fields for drug allergies, patient event summaries; examination notes; one or more sets of vital signs; and nursing instructions. The fields depicted in this data record are merely intended to be illustrative of the possible data contained in the initial patient data record. This initial patient data record would be stored in the healthcare facilities computer database 395. The information is then accessible to the hospital server 375, and then, for example, the specific patient information can be wirelessly upload into a hand-held device 300 for a specific patient. Moreover, additional information can be added to the patient record via the hand-held device 300.

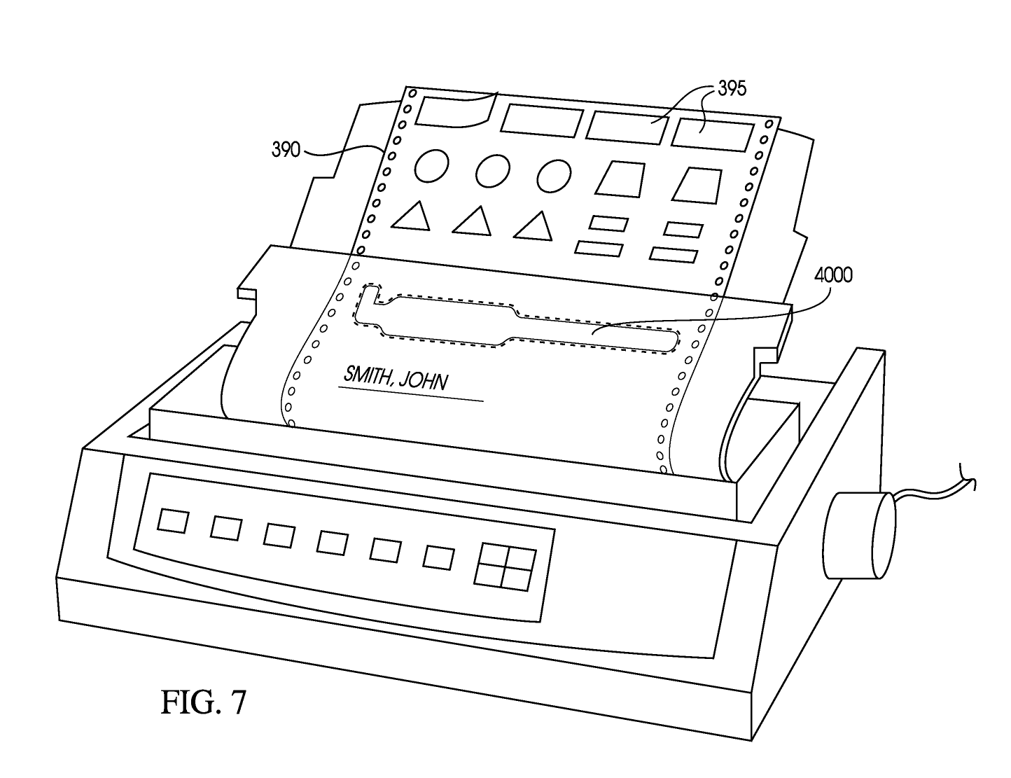

As shown in FIG. 7, after entering the initial patient data record, the record is used to print a new patient admittance sheet 390 comprising pre-printed labels 395 and the patient's identification bracelet 4000. As shown in FIG. 7, the pre-printed labels 395 may be a variety of different shapes to facilitate the use of the labels in a variety of healthcare specific objects such as on blood and urine samples, medication, and medical supplies. The labels may also have a specific color, shape, number, letter, or other modification to more readily identify a particular hospital procedure or test. As further shown in FIG. 7, the completed patient id bracelet 4000 may be printed with the new patient admittance sheet 390 and easily removed via the perforations in the sheet.

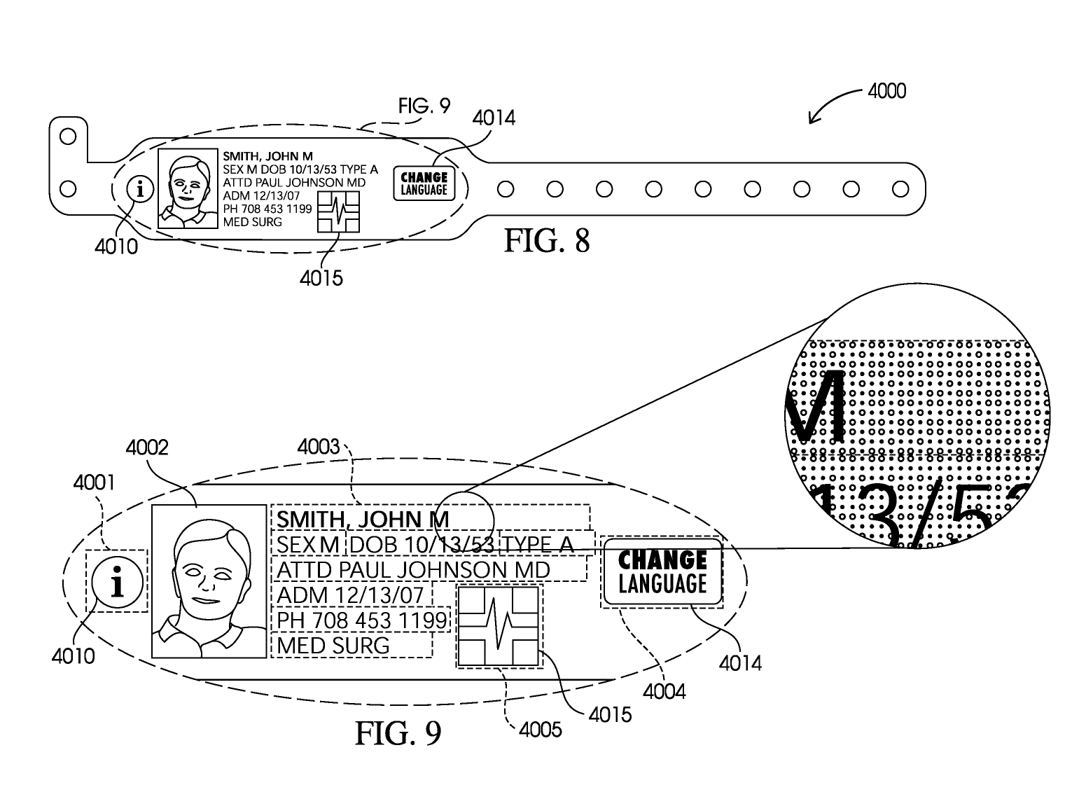

As shown in FIG. 8, the substrate 155 may comprise a patient identification bracelet 4000. As was previously known, patient identification bracelet 4000 is fixed around a patient's wrist or ankle to ensure identification of the patient throughout their stay at the healthcare facility. The patient identification bracelet 4000 is usually printed on a flexible durable substrate such that the printing disposed thereon would be expected to survive the conditions reasonably expected for a patient's stay in the healthcare facility. Although the patient identification bracelet is shown as including a digital photo of the patient, inclusion of such photo is optional. Similarly, other information not shown on the patient identification bracelet 4000 depicted in FIG.8 may be printed on the bracelet by the healthcare facility.

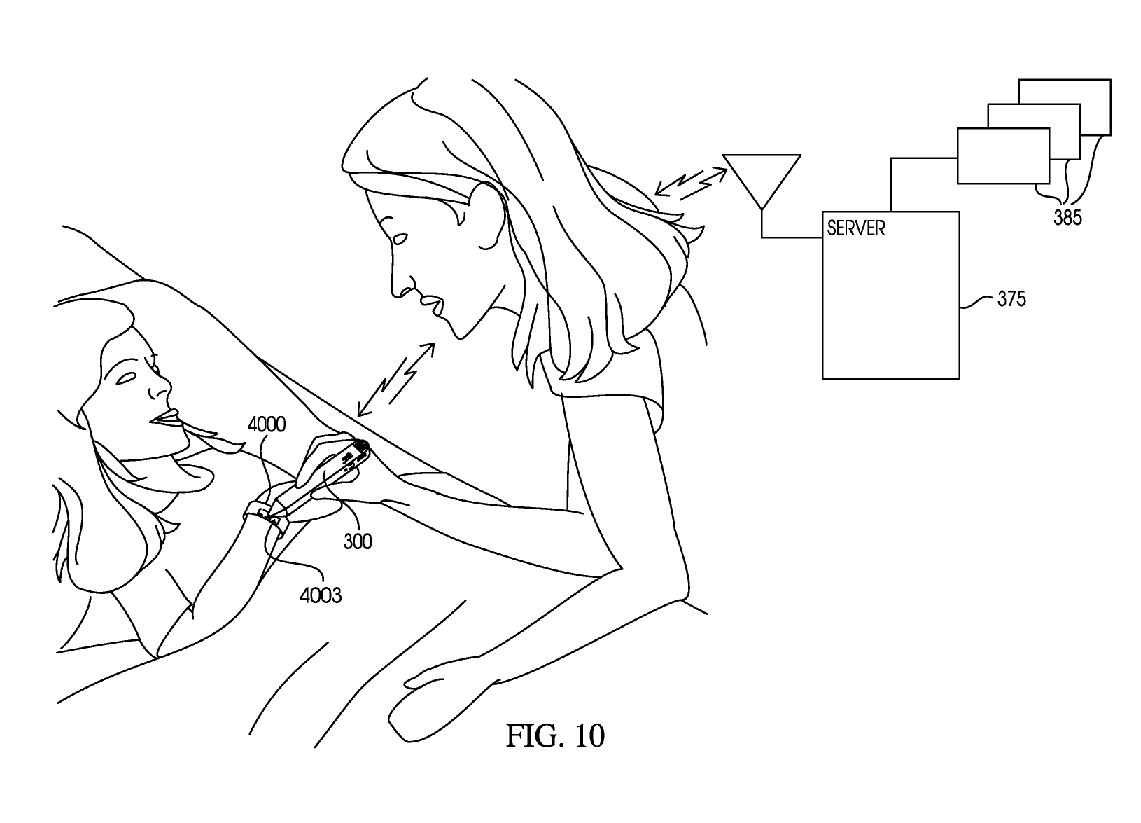

For purposes of the present invention one or more printed codes (not visible to the human eye in FIG. 8 in accordance with the present, invention) are associated with one or more printed regions on the patient identification bracelet. FIG. 9 illustrates some of the printed regions 4001, 4002, 4003, 4004, and 4005 on patient identification bracelet 4000. The patient identification bracelet 4000 illustrated would actually have at least seven more printed regions, which regions are indicated on FIG. 9 but not given reference numbers to avoid obscuring the figure. As shown in FIG. 8 these “regions” are not actually visible to the naked eye in operation.

Within each printed region 4001, 4002, 4003, 4004, and 4005 a single printed code would be repeatedly printed so as to cover the entirety of the select region. These printed codes would be sufficiently unique to the patient such that the codes of a first patient would not be mistaken for the codes of a second patient within the same healthcare facility during the same period of time. The codes may be recycled by the healthcare facility, but preferably not for lengthy periods of time. These printed codes CH 13 may be printed on the substrate 155 at the same time that visible information is printed on the patient identification bracelet 4000 (see FIG. 7) or the regions may be pre-printed on the substrate 155. Where the printed codes are pre-printed on the patient identification bracelet, the healthcare facility would be provided with means for associating the group of preprinted printed codes from the specific patient identification bracelet used for the particular patient. This means may include a hand-held device and the printing of the codes on a designated section of new patient admittance sheet 390.

It should also be understood that some of the visible printing on patient identification bracelet 4000 may also be pre-printed such as information symbol 4010, change language icon 4014, and healthcare facility logo 4015, as illustrated in FIGS. 8 and 9.

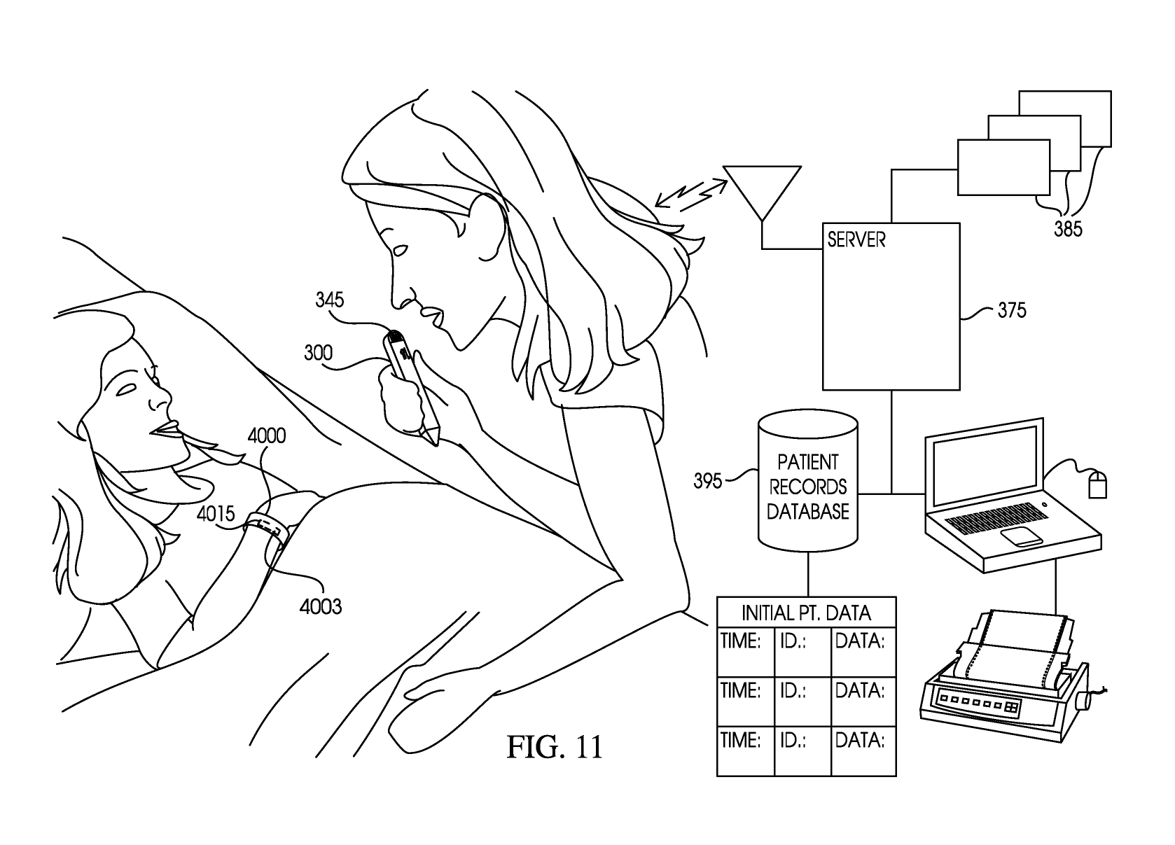

As shown in FIG. 10, a healthcare worker, such as a nurse, caring for the patient may have a hand-held device 300. The non-volatile memory 320 in the device may have been loaded with the patient data records for all of the patients in the healthcare facility or, as may be more likely the case due to memory size constraints, it may have been loaded with relevant portions of the patient data records for patients in the healthcare worker's assigned location within the healthcare facility (e.g. the Surgical Ward). The downloading of the patent data records may be accomplished wirelessly or by wired connection. The healthcare worker touches the hand-held device 300 to a region of the patient identification bracelet, such as region 4003 containing the patient's name. The hand-held device 300 registers the patient name and the device preferably audibly states the patient's name.

The healthcare worker may next touch the hand-held device 300 to the region 4001 including information symbol 4010. In an illustrated embodiment, touching the printed codes associated with information symbol 4010 will cause the hand-held device 300 to audibly read-out any patient event summaries logged in the patient records database 395 within the last few hours (perhaps even eight or more hours) subject to the last update of the non-volatile memory 320 in device 300, which depends on whether the system is updated wirelessly or by wired connection. In a wirelessly updated system, the CH 14 memory 320 onboard the hand-held device 300 may be updated in substantially real time. As is depicted in FIG. 10 via the bi-directional RF arrows, data may be transmitted from a server 375 via an RF antenna to the device 300.

It should be understood that the printed code associated with the information symbol 4010 could be associated with any information included the patient data record, such that the information is read aloud by the hand-held device 300 upon touching the information symbol 4010. In another example, touching the region associated with the visible printing “MED SURG” on the patient identification bracelet would prompt an audible message that may include more information about the surgery, for instance, “patient is admitted for scheduled surgery on his right carotid artery on Jun. 4, 2008.”

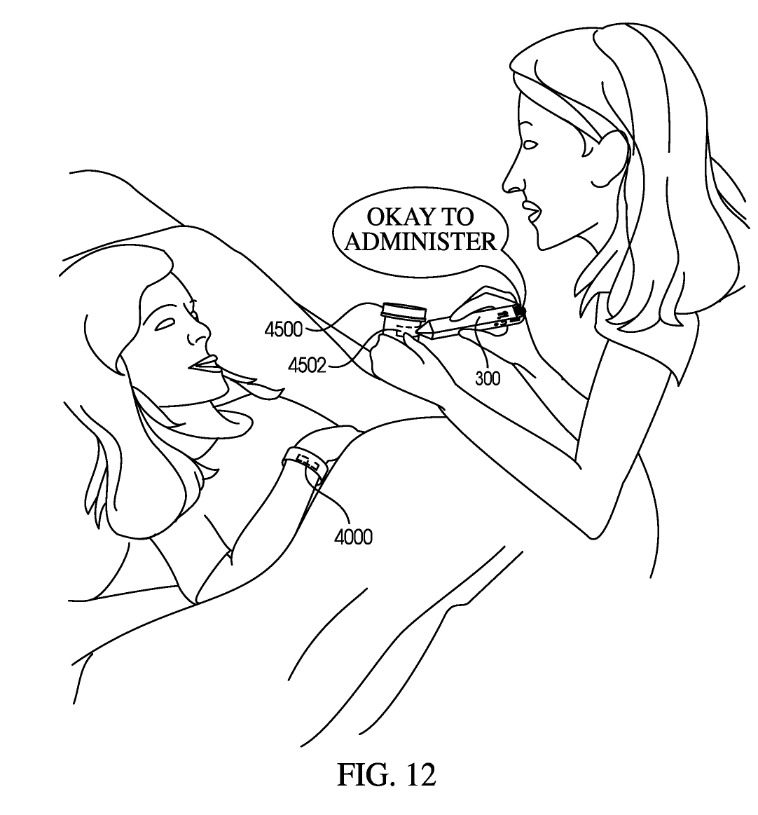

As shown in the illustrated embodiment of FIG. 11, the healthcare worker may record vital signs or other activities conducted in association with the patient directly into the hand-held device 300 using the optional microphone 345. So, for instance, by touching the device to the healthcare facility logo 4015, the hand-held device 300 would record the unique patient identification and may indicate (preferably audibly) that it is ready to receive data and switch into audio record mode. At that time, the healthcare worker would audibly state something like, “BP 120 over 80, pulse 88, temp 99.2, pupils normal, color good” and then touch the healthcare facility logo 4015 again to stop the recording. In addition to the audio record, the recorded record would also include the patient identification (as indicated by the unique printed code associated with the healthcare facility logo 4015), the unique identification number embedded in permanent storage 325 of the hand-held device 300 and would preferably also note the real-time the record was recorded. In addition to being stored on the hand-held device 300, that patent event record may be uploaded to the healthcare facility's computer system. As shown in FIG. 11, this upload may be via a wireless RF link to the server 375 and in turn the patient records database 395. The data saved each patient's record in the database 395 would include the initial patient data from admitting as well as other data such as lab tests, physical examination records, vital sign updates, scheduled testing procedures, nurse's notes, and more. This data can be, inserted from various workstations 385 throughout the healthcare facility or even from a computer in the patient's room. Other than the initial patient data, data is preferably organized by time in reverse chronological order such that the most recent pertinent information is available first.

The healthcare facility's computer system may save the audio record in the patient data record and may also convert the audio record to text. In a preferred embodiment, the text copy of the record (which would include not only the record spoken by the healthcare worker, but also their name and the record time), is used as the source of information read out to healthcare workers that subsequently touch Mr. Smith's information symbol 4010. Using this approach would likely expedite and simplify conversion of the information to another language if such language is needed for the user of another hand-held device.

It should be understood that the healthcare worker could be a phlebotomist taking blood samples and recording into the patient data record using a hand-held device 300 something to the effect of “two vials of blood were drawn,” which would then be associated with the real time, the hand-held device identification number and the patient for recording in the patient data record. Similar examples can be given of physical, occupational, respiratory and other therapists. In, addition, a speech-language pathologist could even use the record function of the hand-held device 300 to record patient speech for diagnostics and later comparison purposes. The system may be taught to recognize the identification of the hand-held device of each healthcare worker such that the system will cause, the appropriate types of records to be generated. Alternatively, the healthcare workers may carry around a printed template that has printed codes 50 embedded thereon to instruct the device to create a variety of records or perform certain tasks.

In another example, the healthcare worker may need to contact the patient's primary doctor as listed on the patient identification bracelet 4000. In one embodiment, touching the region with the doctor's name will cause the hand-held device 300 to audibly read out the doctor's name and contact information. That doctor contact information may be static or it may, preferably be updated in real time in a separate CH 16 record in the healthcare facilities database 395. So, for instance, the default message associated with the printed code printed in that region of the patient identification bracelet illustrated in the figures could be an audible message “Attending physician Paul Johnson MD. Telephone number 555-1212. Pager number 555-1213.” But, when Dr. Johnson wants the night off, he could submit to the healthcare facility computer a message that “Dr. Jane Doe is handling my patients tonight her number is 555-2121.” The computer recognizing “tonight” during speech-to-text translation, could insert the real date. This message would then be associated with Dr. Johnson's record, such that a healthcare worker now touching the doctor region of Mr. Smith's patient identification bracelet 4000 would hear “Attending physician Paul Johnson MD. Dr. Jane Doe is handling patients tonight, Sunday June 1, her number is 555-2121.” It should also be understood that Dr. Johnson's actual recording could be played instead of the textualized version created by the computer.

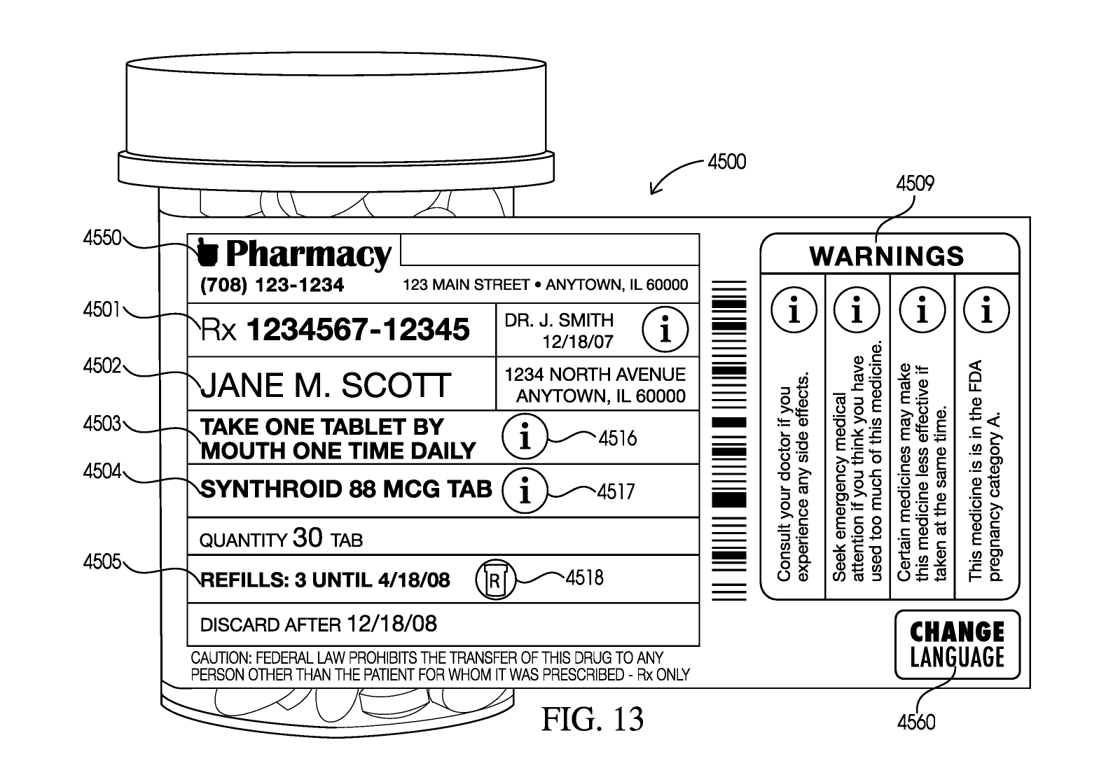

In another example, the healthcare worker may be at the patient's bedside to administer prescribed medication to the patient. After touching the patient identification bracelet 4000, as shown in FIG. 12 the healthcare worker would touch a container baring a label with printed codes. The printed codes on the prescription label may match one of the printed codes on the patient identification bracelet 4000, such as the code associated with the patient name, although the particular code selected is not particularly significant. If the printed code on the label matches the printed code on the patient identification bracelet, then the hand-held device 300 would provide an audible signal that the prescription should be dispensed. In some instances, the patient may need an emergency medication that had not been previously prescribed. In those cases, as well as the prescription example above, the healthcare worker may touch an indicated region on the general medicine packaging that has an associate printed code. If the new medication is in the list of the patient's drug allergies or an interaction warning exists between the new medication and one or more of the medications in the patient data record, an alarm would sound. That alarm may include specific information, such as “patient is allergic to sulfides” or “there is a potentially adverse drug interaction between [drug 1] and [the new medication]”

FIG. 13 illustrates a prescription filled at a retail or mail-order pharmacy enabled for use with the present system. In this example the substrate 155 is the prescription label 4500, which has one or more printed codes not visible to the human eye associated with a respective one or more printed regions on the prescription label 4500. In this particular embodiment of the prescription label 4500, the printed regions 4501, 4502, 4503, 4504, 4505, 4506, 4507, 4508, and 4509, among others not numbered, are actually bounded by visibly printed lines and/or color distinctions. Within each printed region a single printed code would be repeatedly printed so as to cover the entirety of the select region.

The printed codes used. on the prescription label 4500 may be unique or may be set. For instance, the printed code used by the prescription number 4511 and patient name 4512 should be unique within the same pharmacy or group of pharmacies (where they share a coding system). The printed codes for the pharmacy name 4550 and the drug type and dosage 4514, for instance, would not be unique to the prescription label 4500, but would be unique as among other pharmacies, other drugs and other dosages. These printed codes may be printed on the substrate 155 at the same time that visible information is printed on the prescription label 4500. Some of the printed codes may be pre-printed on the substrate 155, particularly in this example where the information is not variable such as pharmacy name 4550. It should also be understood that some of the visible printing may also be pre-printed such as the lines that divide some of the coded regions, the information symbols 4516 and 4517, the refill symbol 4518, and the change language icon 4560.

The interaction between the prescription label 4500 and the hand-held device 300 follows as would be expected having read the present disclosure. For instance, touching the hand-held device 300 to printed region 4501 would result in the prescription number being read aloud by the hand-held device 300 through its audio speaker 340. Similarly, the hand-held device 300 would read aloud the patient name if printed region 4502 is touched; the instructions if printed region 4503 is touched, the medication type and unit dosage if region 4504 is touched, etc. This feature is particularly useful in multi-resident households where one or more residents may be visually-impaired. It is similarly useful where the user may not speak English, in which case, by touching the change language icon 4560 the, hand-held device 300 reads aloud in another language even if the printed matter is in English.

The usage information symbol 4516 provides detailed information regarding the usage of the medication, for instance: “take in the morning,” “take on an empty stomach 30 minutes before eating,” “take with at least 8 oz of water,” “if you miss a dose, take as soon as possible, unless it is almost time for your next dose in which case skip the dose, do not take extra medicine to make up the dose,” “store at room temperature.” This information will vary depending upon the medication. The medicine information symbol 4517 may state the branded name as well as the generic name and could further provide warnings about potential problems in switching from branded to generic drugs. The refill symbol 4518 will order a refill from the pharmacy that originally filled the prescription, if there are refills available. In particular, the user touches the refill symbol 4518 and the hand-held device 300 states aloud, “to confirm that you want to refill your prescription please touch this button again.” After touching the refill symbol 4518 a second time, a refill order record is created in the hand-held device 300 including at least the prescription number of prescription label 4500. If the hand-held device 300 has a operative connection to the pharmacy (either directly via wireless connection or via the Internet), the order will be placed.

The prescription label 4500 may also have a printed region coded that could be touched immediately before the next dose of the medication is taken. By touching this symbol with the hand-held device 300 a record is saved that the medication was taken at the time recorded by the hand-held device 300. In any subsequent attempt to take the medication, the symbol would be touched again and the current time will be compared to the previous time record. If the time between doses is too close a user-perceivable warning will be issued by the hand-held device 300, such as an audible warning “do not take this medication yet, it is too soon since your last dose.” The user may override the message, take the medication and record the new time by touching the dosing symbol for a second time.

The prescription label 4500 may also help in the pharmacy to better ensure the correct drug is being dispensed. For instance, the printed code could be printed either on a unit or bulk container of the medication or even directly on the surface of certain medications. In either case, during the process of filling the prescription the pharmacy worker could touch the hand-held device 300 to the mediation indicated on the prescription label 4500 at region 4504 and then touch the coded region on the bulk container or on the medication itself. A pleasant tone or warning sound may be used to indicate whether there is a match.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. An information system comprising:
an electronically-accessible data record, including a patient data record;
a substrate having thereon one or more printed codes practically imperceptible to a human being; and
a device having an optical reader capable of reading a selected one of the one or more printed codes on the substrate, non-volatile memory and a controller, the device further having means for providing humanly perceptible feedback, the non-volatile memory storing the patient data. record.

2. The invention according to claim 1 wherein at least one of the one or more printed codes are printed on the substrate.

3. The invention according to claim 2 wherein the substrate has pre-printed material that is visible to the naked eye.

4. The invention according to claim 3 wherein one of the one or more printed codes is in substantial registration with at least some of the visible pre-printed material.

5. The invention according to claim 1 wherein the one or more printed codes are printed on a printable layer of an intermediate substrate, the intermediate substrate further having an adhesive layer.

6. The invention according to claim 5 wherein the intermediate substrate is made of materials that do not significantly obscure the substrate.

7. The invention according to claim 6 wherein the intermediate substrate further includes a protective layer on top of the printable layer, wherein the protective layer is made of a material that does not significantly obscure the ability of the optical reader to read the printed code.

8. The invention according to claim 7 wherein the intermediate substrate is provided on a sheet with one or more additional intermediate substrates, each of the one or more additional intermediate substrates having a printable layer, an adhesive layer, and a protective layer on top of the printable layer, wherein each additional intermediate substrate is made of materials that do not significantly obscure the substrate and the protective layer is made of a material that does not significantly obscure the ability of the optical reader to read the printed code on each intermediate substrate.

9. The invention according to claim 8. wherein each of the additional intermediate substrates is a different shape than the intermediate substrate.

10. The invention according to claim 8 wherein the one or more printed codes are variably printed on the printable layer of the intermediate and additional intermediate substrates.

11. The invention according to claim 1 wherein the device further includes circuitry for updating the non-volatile memory.

12. The invention according to claim 11 wherein the circuitry for updating the non-volatile memory further includes a wired connector.

13. The invention according to claim 11 wherein the circuitry for updating the non-volatile memory further includes a first radio transceiver, the system further including a server having a second radio transceiver and a data record creation, storage and update subsystem operably connected to the second radio transceiver, the second radio transceiver being operably and selectively connected to the first radio transceiver.

14. The invention according to claim 13 wherein the device further includes means for recording data into the device.

15. The invention, according to claim 14 wherein the means for recording data into the device comprises an audio microphone.

16. The invention of claim 15 wherein the substrate is a patient identification bracelet associated with a patient in a healthcare facility.

17. The invention according to claim 16 wherein the radio transceiver sends the recorded data via the first and second radio transceivers to the data record creation, storage and update subsystem along with a device identification code and data sufficient to determine a patient identification code, the device identification code being stored in the non-volatile memory of the device and the data sufficient to determine the patient identification code being read from the printed codes on the patient identification bracelet.

18. The invention of claim 16 further including a second substrate wherein the second substrate is a prescription label, the second substrate having thereon one or more printed codes practically imperceptible to a human being, the optical reader capable of reading a selected one of the one or more printed codes on the second substrate, the non-volatile memory having code stored therein to operate the controller to provide humanly perceptible feedback indicative of the desirability of providing the prescription medication to the patient.

19. The invention of claim 1 wherein the substrate is a prescription label.

20. The invention of claim 19 wherein the prescription label has pre-printed material that is visible to the naked eye and one of the one or more printed codes is in substantial registration with at least some of the visible pre-printed material.

21. The invention of claim 20 wherein the device further includes circuitry for updating the non-volatile memory, the memory update circuitry being operably and selectively connected to a server associated with a healthcare facility such that the non-volatile memory of the device will be updated with data associated with the prescription label.

22. The invention of claim 21 wherein the healthcare facility is a retail pharmacy.

23. The invention of claim 22 wherein the system further includes a printer for printing visibly printed material on the prescription label in substantial registration with selected ones of the one or more, printed codes, the visibly printed material reflecting a prescription prescribed for a patient, the non-volatile memory of the device having audio data reflecting the visibly printed material associated with the selected ones of the one or more printed codes.

24. The invention of claim 23 wherein the visible pre-printed material and associated printed code are associated with programming and data sufficient to contact the retail pharmacy to order a refill of the prescription.

25. The invention of claim 20 wherein the visible pre-printed material and associated printed code are associated with programming and data sufficient to order a refill of an associated prescription.

26. A method of maintaining real-time information regarding a patient in a healthcare facility comprising:
printing a patient identification bracelet associated with the patient;
associating one or more codes printed on the patient identification bracelet such that they are practically imperceptible to a human being with personal data regarding the patient;
placing the patient identification bracelet physically on the patient;
touching the patient identification bracelet with a device having an optical reader capable of reading a selected one of the one or more printed codes on the patient identification bracelet, non-volatile memory and a controller, the device further having means for providing humanly perceptible feedback; and
providing humanly perceptible feedback related to the touched one or more printed codes on the patient identification bracelet.

27. The method of claim 26 further comprising recording information regarding the patient into the device within a predetermined time of touching a selected one of the one or more printed codes on the patient identification bracelet.

28. The method of claim 27 further comprising transmitting the recorded information regarding the patient along with a patient identifier and device identifier from the device to a server.

29. The method of claim 28 further comprising transmitting the recorded information, the patient identifier and device identifier from the server to another device.
